(19) United States
(12) Patent Application Publication
(10) Pub. No.: US 2025/0065278 A1
(43) Pub. Date: Feb. 27, 2025

(54) METHOD OF REMOVING AN ORGANIC MICROPOLLUTANT FROM A TREATMENT SOLUTION

(71) Applicant: KING FAHD UNIVERSITY OF PETROLEUM AND MINERALS, Dhahran (SA)

(72) Inventors: Asif MATIN, Dhahran (SA); Nadeem BAIG, Dhahran (SA); Irshad AHMAD, Dhahran (SA); Deepak ANAND, Dhahran (SA)

(73) Assignee: KING FAHD UNIVERSITY OF PETROLEUM AND MINERALS, Dhahran (SA)

(21) Appl. No.: 18/456,167

(22) Filed: Aug. 25, 2023

(51) Int. Cl. B01D 69/14; B01D 61/02; B01D 69/02; B01D 69/12; B01D 71/02; B01D 71/56; B01J 20/06; B01J 20/26; B01J 20/28; C02F 1/44

(52) U.S. Cl. CPC B01D 69/14111; B01D 61/027; B01D 69/02; B01D 69/12; B01D 69/148; B01D 71/024; B01D 71/56; B01J 20/06; B01J 20/262; B01J 20/265; B01J 20/28004; B01J 20/28019; B01J 20/28026; B01J 20/28033; B01J 20/2808; B01J 20/28083; C02F 1/442; B01D 2325/02831; B01D 2325/02832; B01D 2325/04; B01D 2325/26; B01D 2325/36; C02F 2101/34; C02F 2101/36; C02F 2101/38; C02F 2101/40; C02F 2103/08

(57) ABSTRACT

A method of removing an organic micropollutant from a treatment solution including passing the treatment solution through a membrane, and collecting a filtered solution. The filtered solution contains at least 50% less of the organic micropollutant than the treatment solution. The membrane includes a polysulfone support and an active layer containing zinc oxide (ZnO) nanoparticles.

### STATEMENT OF ACKNOWLEDGEMENT

Support provided by King Fahd University of Petroleum and Minerals (KFUPM) is gratefully acknowledged.

### BACKGROUND

### Technical Field

The present disclosure is directed to a membrane, particularly, to a method for removing an organic micropollutant from a treatment solution using a membrane.

### Description of the Related Prior Art

The description of the related prior art provided herein is for the purpose of generally presenting the context of the disclosure. Work of the presently named inventors, to the extent described in this background section, as well as aspects of the description which may not otherwise qualify as prior art at the time of filing, are neither expressly nor impliedly admitted as prior art against the present invention.

Sustainably providing clean and potable water is a challenge as large volumes of domestic, commercial, industrial, and municipal wastewater are discharged into natural water sources such as rivers, lakes, and oceans. Organic micropollutants (OMPs) such as drugs, antibiotics, cosmetics, dyes, and personal care products are also detected in ground and surface waters. The presence of these compounds in drinking water is a matter of concern as many of these are known to possess deleterious effects on human health. Currently, wastewater is treated using multiple steps and techniques, including biological processes combined with chemical and physical treatment methods. However, these methods only partially remove the byproducts of several pharmaceuticals, drugs, cosmetics, and personal care products. Consequently, OMPs enter the surface waters in trace concentrations, ranging from ng/L to μg/L, threatening human health and marine life.

Membranes are gaining attention for purifying different types of water and waste streams. The membrane processes can be classified as (a) microfiltration, (b) ultrafiltration, (c) nanofiltration (NF), and (d) reverse osmosis (RO) based on their average pore sizes. Due to the very small pore size (˜0.5-2 nm), the latter two processes can remove organic molecules with a molecular weight as low as 200 Da, with high efficiency. Therefore, research efforts have focused on using NF/RO membranes to remove organic micropollutants with different attributes such as hydrophobicity, molecular weight, electric charge, etc., and on the surface modification of existing commercial membranes to improve the removal efficiency of OMPs.

Surface modification of membranes is accomplished in one of the following manners: (i) deposition of thin film or grafting of macromolecules on the commercial membrane, and (ii) incorporation of nanomaterials and/or functional groups into the active layer during the membrane synthesis. Although promising, a major handicap associated with surface modification is the compromise of the water permeability properties of the membrane, which is undesirable for economic reasons. The presence of a coating implies the addition of another barrier layer, which increases the membrane's hydraulic resistance. Also, membrane fouling is another obstacle in the sustainable removal of organic compounds. Fouling occurs when the organic molecules attach to the membrane surface by hydrophobic and electrostatic interactions and with time, form a thick layer that acts as an extra barrier to water passage and decreases the removal efficiency. Although thin-film nanocomposite membranes have been developed in the past, there still exists a need to develop membranes with improved flux, high permeability, and stable rejection for wastewater treatment and methods of use to treat water contaminated with OMP.

Therefore, a method of removing an organic micropollutant from a treatment solution which overcomes the above limitations is needed. Accordingly, an object of the present disclosure is to provide a membrane and a method of filtration with the membrane that has antifouling properties, improved flux, and high removal efficiency of OMPs.

### SUMMARY

In an exemplary embodiment, a method of removing an organic micropollutant from a treatment solution is described. The method includes passing the treatment solution through a membrane, and collecting the filtered solution, wherein the filtered solution includes at least 50% less of the organic micropollutant than the treatment solution. The membrane includes a polysulfone support and an active layer containing zinc oxide (ZnO) nanoparticles. The active layer also includes polymerized units of a piperazine compound and an aromatic compound with at least three acyl chloride substituents. A surface of the ZnO nanoparticles is functionalized with a silane amine compound, and an amine group of the silane amine compound is crosslinked with at least one of the at least three acyl chloride substituents.

In some embodiments, the ZnO nanoparticles have an average size of 100-500 nanometers (nm).

In some embodiments, at least a portion of the ZnO nanoparticles are agglomerated and form agglomerates with an average size of 500-1,500 nm.

In some embodiments, at least a portion of the ZnO nanoparticles are spherical.

In some embodiments, the ZnO nanoparticles are uniformly distributed over an entire surface of the active layer, wherein an average spacing between the ZnO nanoparticles is 0.5-3 micrometers (μm).

In some embodiments, the membrane includes 65-75 wt. % C, 5-15 wt. % 0, 5-15 wt. % N, 1-10 wt. % S, 0.1-1.0 wt. % Cl, and 0.1-1.0 wt. % Zn, based on a total weight of the membrane.

In some embodiments, the membrane includes 10-100 parts per million (ppm) of the ZnO nanoparticles relative to a total weight of the active layer.

In some embodiments, the silane amine compound has a straight or branched chain with 4-20 atoms attached to a silane group, wherein the amine group crosslinked with at least one of the at least three acyl chloride substituents is a terminal amine group on the chain.

In some embodiments, the silane amine compound is N1-(3-trimethoxysilylpropyl) diethylenetriamine.

In some embodiments, the piperazine compound is piperazine.

In some embodiments, the aromatic compound with at least three acyl chloride substituents is 1,3,5-benzenetricarbonyl trichloride.

In some embodiments, the membrane has a water contact angle of less than 25°.

In some embodiments, the membrane has an average surface area roughness of 24-29 nm.

In some embodiments, the membrane has a zeta potential of from −5 to −7 mV.

In some embodiments, the active layer has a thickness of 100 to 500 nm.

In some embodiments, the membrane has pores with the largest dimension of 0.5-5 nm.

In some embodiments, the treatment solution includes 1-500 ppm of the organic micropollutant, based on the total weight of the treatment solution.

In some embodiments, the organic micropollutant is at least one selected from the group consisting of sulfamethoxazole, amitriptyline, omeprazole, and loperamide.

In some embodiments, the treatment solution is wastewater, drinking water, or seawater.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a flowchart depicting a method of removing an organic micropollutant from a treatment solution, according to certain embodiments;

FIG. 2A shows three-dimensional (3D) molecular structure of sulfamethoxazole (SMX), according to certain embodiments;

FIG. 2B shows a 3D molecular structure of amitriptyline (ATT), according to certain embodiments;

FIG. 2C shows a 3D molecular structure of omeprazole (OMZ), according to certain embodiments;

FIG. 2D shows a 3D molecular structure of loperamide HCl (Lop HCl.), according to certain embodiments;

FIG. 3A shows a schematic illustration depicting formation of pristine thin film composite (TFC) membrane, according to certain embodiments;

FIG. 3B is a schematic illustration depicting formation of N1-(3-trimethoxysilylpropyl) diethylenetriamine (TAS) functionalized ZnO grafted piperazine-based thin film nanocomposite (TFN) membrane (TAS-Z-PiP-TFN), according to certain embodiments;

FIG. 4 shows Fourier-transform infrared spectroscopy (FTIR) spectra of non-functionalized (Z-PiP-TFN) membrane and the TAS-Z-PiP-TFN membrane, according to certain embodiments;

FIG. 5A shows a water contact angle (WCA) on the surface of the pristine TFC membrane, according to certain embodiments;

FIG. 5B shows a WCA of the TAS-Z-PiP-TFN-membrane, according to certain embodiments;

FIG. 5C is a histogram showing the values of the WCA on the surface of the pristine TFC membrane and the TAS-Z-PiP-TFN membrane, according to certain embodiments;

FIG. 6A-FIG. 6D shows scanning electron microscopy (SEM) images of the TAS-Z-PiP-TFN-membrane, at different magnifications, according to certain embodiments;

FIG. 7 shows an energy dispersive X-ray spectroscopy (EDX) spectrum for the TAS-Z-PiP-TFN-membrane, according to certain embodiments;

FIG. 8A shows an atomic force microscopy (AFM) image of the pristine TFC membrane, according to certain embodiments;

FIG. 8B shows an AFM image of the Z-PiP-TFN membrane, according to certain embodiments

FIG. 8C shows an AFM image of the TAS-Z-PiP-TFN-membrane, according to certain embodiments;

FIG. 9 shows zeta potential values for the pristine TFC membrane, the Z-PiP-TFN membrane, and the TAS-Z-PiP-TFN-membrane, according to certain embodiments;

FIG. 10 shows pure water flux and NaCl rejection for a 1260 ppm NaCl feed for the Z-PiP-TFN, and the TAS-Z-PiP-TFN-membranes at a pressure of ˜200 psi (14 bars), according to certain embodiments;

FIG. 11 shows rejection values for the organic compounds, SMX, ATT, OMZ, and LOP, by the TAS-Z-PiP-TFN-membrane and commercial membrane (XN45 and NFG) from a feed of concentration 10 ppm, according to certain embodiments;

FIG. 12A shows percentage rejection for each membrane for the organic compounds, SMX, ATT, OMZ, and LOP, according to certain embodiments;

FIG. 12B shows fouling behavior of the XN45 membrane after running with a 10 ppm loperamide feed for ˜4 hours, according to certain embodiments;

FIG. 12C shows fouling behavior of the TAS-Z-PiP-TFN-membrane after running with a 10 ppm loperamide feed for ˜4 hours, according to certain embodiments;

FIG. 13A and FIG. 13D shows SEM images of the pristine TFC membrane after exposure to P. aeruginosa for 6 hours in static conditions, according to certain embodiments;

FIG. 13B and FIG. 13E show SEM images of the TAS-Z-PiP-TFN-membrane after exposure to P. aeruginosa for 6 hours in static conditions, according to certain embodiments; and

FIG. 13C and FIG. 13F show SEM images of the XN45 membrane after exposure to P. aeruginosa for 6 hours in static conditions, according to certain embodiments.

### DETAILED DESCRIPTION

When describing the present disclosure, the terms used are to be construed in accordance with the following definitions, unless a context dictates otherwise. Embodiments of the present invention will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a,” “an” and the like generally carry a meaning of “one or more,” unless stated otherwise.

Furthermore, the terms “approximately”, “approximate”, “about,” and similar terms generally refer to ranges that include the identified value within a margin of 20%, 10%, or preferably 5%, and any values therebetween.

The use of the terms “include,” “includes”, “including,” “have,” “has,” or “having” should be generally understood as open-ended and non-limiting unless specifically stated otherwise.

As used herein, “particle size” may be thought of as the length or longest dimension of a particle.

As used herein, the term “membrane” as used herein refers to a porous structure that is capable of separating components of a homogeneous or heterogeneous fluid. In particular, “pores” in the sense of the present disclosure indicate voids allowing fluid communication between different sides of the structure. More particularly, when in use a homogeneous or heterogeneous fluid is passed through the membrane, some components of the fluid can pass through the pores of the membrane into a “permeate stream”, while some components of the fluid can be retained by the membrane and can thus accumulate in a “retentate” and/or some components of the fluid can be rejected by the membrane into a “rejection stream”. Membranes can be of various thicknesses, with homogeneous or heterogeneous structures. Membranes can be in the form of flat sheets or bundles of hollow fibers. Membranes can also be in various configurations, including but not limited to spiral wound, tubular, hollow fiber, and other configurations identifiable to a skilled person upon a reading of the present disclosure. Membranes can also be classified according to their pore diameter. Membranes can be neutral or charged, and particle transport can be active or passive. The latter can be facilitated by pressure, concentration, and chemical or electrical gradients of the membrane process.

As used herein, “co-precipitation” is a sort of precipitation where soluble compounds in a solution are removed during precipitation. The precipitate may be separated from the reaction mixture by methods including, but not limited to, filtration, decantation, and evaporation.

As used herein, “nanoparticles” are particles having a particle size of 1 nm to 500 nm within the scope of the present invention.

As used herein, “organic micropollutants (OMPs)” refer to the organic compounds found in surroundings at trace amounts, usually ranging from μg/L to <ng/L.

As used herein, “water contact angle” refers to a measure of the wettability of a solid surface. Hydrophobic solids have a contact angle above 90°, and hydrophilic solids have a contact angle below 90°.

As used herein, “zeta potential” refers to a measure of the electrical charge developed when a solid surface is brought into contact with an aqueous solution.

As used herein, “filtration” refers to the mechanical or physical operation that can be employed for the separation of constituents of homogeneous or heterogeneous solutions. Types of filtration can be categorized by the estimated sizes of chemicals to be separated and can involve particle filtration (>10 μm); microfiltration (0.1-10 μm); ultrafiltration (0.01-0.1 μm); nanofiltration (NF) (0.001-0.01 μm); and reverse osmosis, or RO (<0.001 μm).

As used herein, “functional group” indicates specific groups of atoms within a molecular structure that are accountable for the characteristic chemical reactions and chemical properties of that structure. Suitable examples of functional groups include hydrocarbons, groups containing halogen, groups containing oxygen (alcohol, acid, ketone, aldehydes), groups containing nitrogen (nitrile, amines, amides), groups containing silicon (silanes) and groups containing phosphorus and sulfur all identifiable by a skilled person.

As used herein, “attach” or “attachment” refers to linking or uniting by a bond, link, force, or tie in order to keep two or more parts together, preferably of directly adjacent materials which encompasses either direct or indirect attachment such that, for example, a first compound is directly bound to a second compound or material, and the embodiments wherein one or more intermediate compounds, and in particular molecules, are disposed between the first compound and the second compound or material.

Aspects of the present disclosure are directed to a thin-film nanocomposite (TFN) membrane to remove organic micropollutants (OMPs). The membrane includes functionalized zinc oxide (ZnO) nanoparticles covalently cross-linked into the active layer. The resulting membrane has improved removal of OMPs, improved flux, high permeability, and high stability.

A filtration membrane, also referred to as a membrane, is described. The membrane includes a support, and an active layer. The membrane is fabricated by incorporating the active layer on the support. In some embodiments, the active layer covers at least 50%, preferably 60%, more preferably 80%, and yet more preferably more than 95% of the surface of the support. The support should possess good mechanical and thermal properties. Also, the support should demonstrate high resistance to chemicals such as aromatic hydrocarbons, ketones, ethers, and esters. The support includes a polymer component configured to strengthen the membrane structure. Suitable polymers to be included in support layers comprise, for example, poly (vinylidene) fluoride (PVDF), poly (tetrafluoroethylene) (PTFE), poly (acrylonitrile) (PAN), poly (methyl methacrylate) (PMMA), poly (methacrylic acid) (PMAA), poly (acrylic acid) (PAA), poly (vinyl methyl ketone), and poly (ethylene terephthalate) (PET), polysulfone (PS), polyethersulfone (PES), poly (ether sulfone) (PSF), polyacrylonitrile (PAN), polypropylene (PP), polyimide (PI), and poly (arylene ether nitrile ketone) (PPENK), which can used alone or in combination. In a preferred embodiment, the support is polysulfone support. Although the description herein refers to the use of PS support, it may be understood by a person skilled in the art that other polymeric supports may be used as well, albeit with a few variations, as may be obvious to a person skilled in the art. The support may be prepared by any of the conventional methods known in the art—for example, a phase inversion method or an electrostatic spinning method. In a preferred embodiment, the PS support is prepared by the phase inversion method.

The active layer includes polymerized units of a piperazine compound and a second monomer. Piperazine is an organic compound having a six-membered ring containing two nitrogen atoms. A general formula of the piperazine compound is shown below in Formula (I).

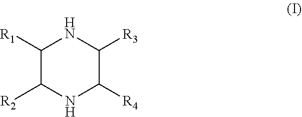

In Formula (I), R₁, R₂, R₃, and R₄ are the same or different and are selected from the group consisting of hydrogen, a halogen, a phenyl, or an alkyl chain having 1-10 carbon atoms. In a preferred embodiment, the piperazine compound is piperazine, where R₁, R₂, R₃, and R₄ are all hydrogen.

The active layer includes polymerized units of a second monomer with the piperazine. The second monomer should comprise at least two, preferably three or four of a functional group which is capable of bonding with a N atom in the piperazine. In an embodiment, the functional group is selected from an acyl halide (R—COX, X is Cl, Br, or I), an ester (R—COO—R), an amine (R—NH₂), an aldehyde (R—COH), or a ketone (R—CO—R). In a preferred embodiment, the functional groups on the second monomer are all the same. In a most preferred embodiment, the functional groups are at least three acyl chlorides.

In a preferred embodiment, the at least three acyl chlorides are attached to an aromatic compound. In some embodiments, the at least three acyl chlorides are attached to a benzene, toluene, naphthalene, biphenyl, or an anthracene. In a most preferred embodiment, the aromatic compound with at least three acyl chloride substituents is 1,3,5-benzenetricarbonyl trichloride.

The piperazine compound and the aromatic compound with at least three acyl chloride substituents are polymerized to form an alternating structure as shown by Formula (II) below.

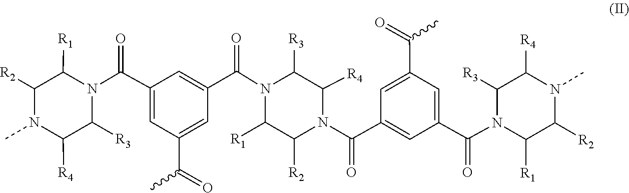

In Formula (II) the aromatic compound with at least three acyl chloride substituents is 1,3,5-benzenetricarbonyl trichloride, however, one of ordinary skill in the art would recognize that this could be replaced by a suitable compound and have a similar connectivity. In Formula (II) the dashed line ---- is a polymerization point where another of the acyl chloride groups of the aromatic compound with at least three acyl chloride substituents, would react to form a bond. In Formula (II) the wavy line [symbol] is an unreacted group, particularly an unreacted acyl chloride group, where an additional component may be bonded to the polymer, as discussed below. If the aromatic compound does not have at least three acyl chloride substituents, for example it has only two, then the compound can only polymerize with the piperazine compound and cannot further form a bond with another component.

In some embodiments, the polymerization of at least three acyl chloride substituents and the piperazine compound forms a polymer with a weight average molecular weight of 500-100,000 g/mol, preferably 1,000-90,000, 20,000-80,000, 30,000-70,000, 40,000-60,000, or about 50,000 g/mol.

In some embodiments, the membrane also contains zinc oxide nanoparticles (ZnO). In some embodiments, the ZnO nanoparticles may be doped with another metal selected from the group consisting of Mg, Al, Fe, Ga, Li, Cr, Co, Be, K, Ca, Ti, and Cu. In a preferred embodiment, the ZnO particles consist of Zn and O.

In an embodiment, the ZnO nanoparticles have an average size of 100-500 nm, preferably 105-495, preferably 110-490, preferably 115-485, preferably 120-480, preferably 125-475, preferably 130-470, preferably 135-465, preferably 140-460, preferably 145-455, preferably 150-450, preferably 155-445, preferably 160-440, preferably 165-435, preferably 170-430, preferably 175-425, preferably 180-420, preferably 185-415, preferably 190-410, preferably 195-405, preferably 200-400, preferably 205-395, preferably 210-390, preferably 215-385, preferably 220-380, preferably 225-375, preferably 230-370, preferably 235-365, preferably 240-360, preferably 245-355, preferably 250-350, preferably 255-345, preferably 260-340, preferably 265-335, preferably 270-330, preferably 275-325, preferably 280-320, preferably 285-315, preferably 290-310, preferably 295-305, or preferably 300-304 nm.

In an embodiment, at least a portion of the ZnO nanoparticles are spherical, preferably 50%, 60%, 70%, 80%, 90%, or 100% of the ZnO nanoparticles are spherical. In some embodiments, ZnO nanoparticles could also exist as nanowires, nanocrystals, nanorectangles, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanoflowers, etc., and mixtures thereof.

In an embodiment, a surface of the ZnO nanoparticles is passivated with —OH groups. In an embodiment, a surface of the ZnO nanoparticles is functionalized with a silane amine compound by reacting the silane amine compound with the —OH on the surface. As used herein, silane refers to R₅—Si (OR₆)₃, where R₅ is a straight or branched chain with 4-20 atoms, preferably 6-18, 8-16, 10-14, or about 12 atoms, and R₆ is an alkyl group with 1-6 carbon atoms. In a preferred embodiment, one end of the silane amine compound is a silane group and an other end is a terminal amine. In a preferred embodiment, the chain includes C, N and/or O atoms. Suitable examples of the silane amine compounds include N¹-(3-trimethoxysilylpropyl) diethylenetriamine, 2-N-silyl-1,3,5-triazine-2,4,6-triamine, 2-N′-silyl-5-trimethoxysilylpentane-1,2,2-triamine. In a preferred embodiment, the silane amine compound is an N′-(3-trimethoxysilylpropyl) diethyltriamine.

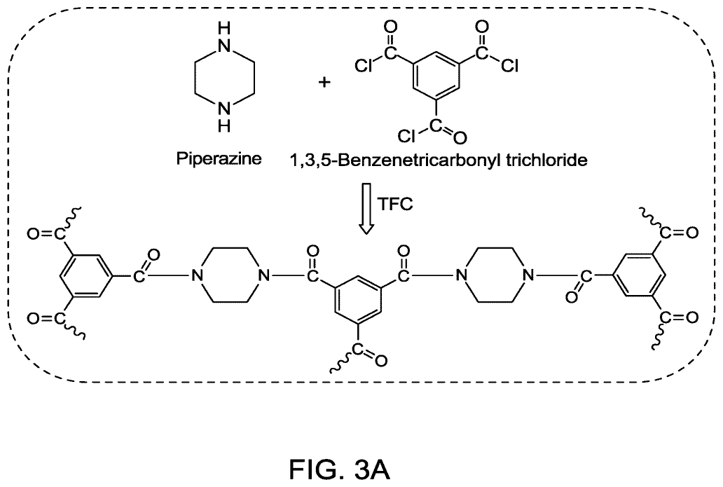

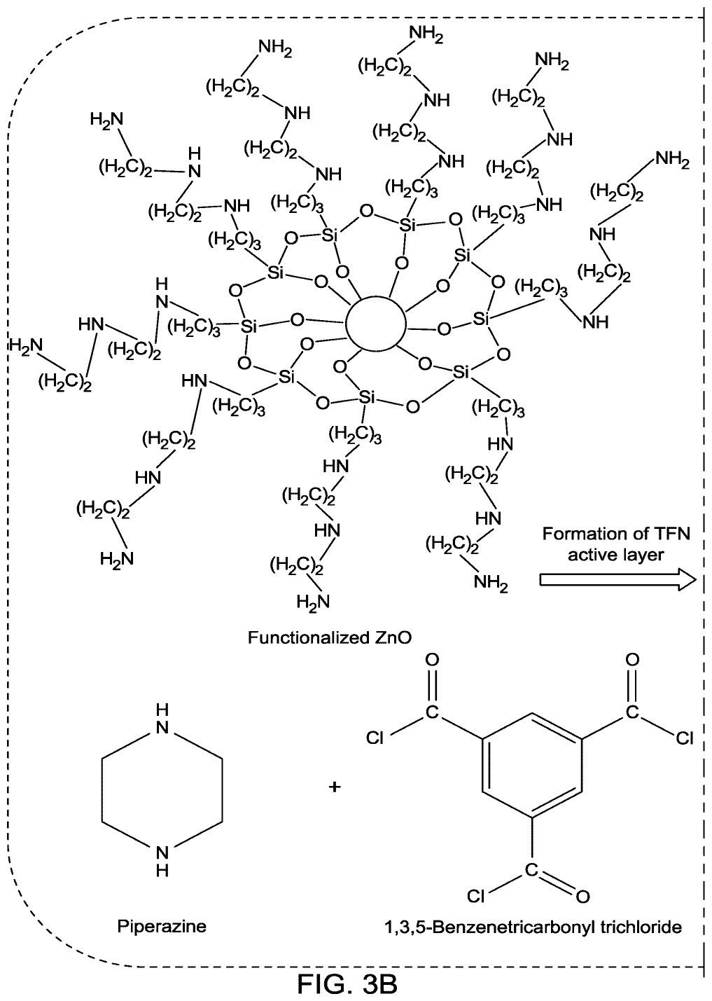

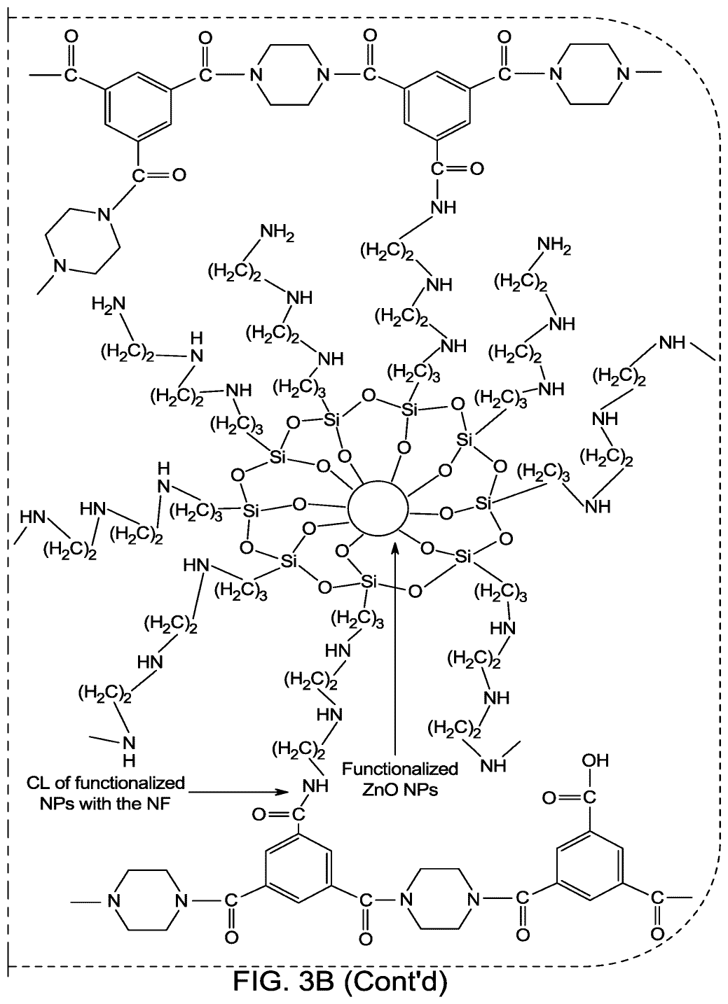

The silane Si(OR₆)₃ of the silane amine compound reacts with the —OH to form a —O—Si bond, thereby covalently bonding the silane amine compound to a surface of the ZnO nanoparticles. The silane amine compound is also connected to other units of the silane amine compound around a surface of the ZnO nanoparticle by O—Si—O bonds, an embodiment of which is depicted in FIG. 3B. In a preferred embodiment, the O—Si—O bonds are continuous around an entire surface of the ZnO nanoparticle. In an embodiment, the bonding is only on one individual particle and does not extend between separate nanoparticles.

In an embodiment, an amine group of the silane amine compound is crosslinked with at least one of the three acyl chloride substituents. In an embodiment, the amine group of the silane amine compound is crosslinked with the non-polymerized acyl chloride substituents as shown by the wavy line in Formula (II). In a preferred embodiment, the amine group crosslinked with at least one of the at least three acyl chloride substituents is a terminal amine group on the silane amine compound chain. Thereby the ZnO nanoparticles are covalently bonded into the active layer of the membrane.

In some embodiments, at least a portion of the ZnO nanoparticles are agglomerated, and form agglomerates with an average size of 500-1,500 nm, preferably 550-1450, preferably 600-1400, preferably 650-1350, preferably 700-1300, preferably 750-1250, preferably 800-1200, preferably 850-1150, preferably 900-1100, preferably 950-1150, and preferably 1000-1100. Agglomeration is due to the presence of N—H groups in their vicinity and the silane groups. In a preferred embodiment, less than 30% of the ZnO nanoparticles are agglomerated, preferably less than 20%, 10%, or there are no agglomerates

In an embodiment, ZnO nanoparticles are uniformly distributed over an entire surface of the active layer. In an embodiment, an average spacing between the ZnO nanoparticles is 0.5-3 μm, preferably 0.7-2.8, preferably 0.9-2.6, preferably 1.1-2.4, preferably 1.3-2.2, preferably 1.5-2.0, and preferably 1.7-1.8 μm.

In an embodiment, the membrane includes 10-100 ppm of the ZnO nanoparticles relative to the total weight of the active layer, preferably 15-95, preferably 20-90, preferably 25-85, preferably 30-80, preferably 35-75, preferably 40-70, preferably 45-70, preferably 50-65, and preferably 55-60 ppm.

In some embodiments, the membrane includes carbon in an amount of 65-75 wt. %, preferably 66-74, preferably 67-73, preferably 68-72, preferably 69-71, oxygen in an amount of 5-15 wt. %, preferably 6-14, preferably 7-13, preferably 8-12, preferably 9-11 wt. %, nitrogen in an amount of 5-15 wt. %, preferably 6-14, preferably 7-13, preferably 8-12, preferably 9-11 wt. %, sulfur in an amount of 1-10 wt. %, preferably 2-9, preferably 3-8, preferably 4-7, preferably 5-6 wt. %, chlorine in an amount of 0.1-1.0 wt. %, preferably 0.2-0.9, preferably 0.3-0.8, preferably 0.4-0.7, preferably 0.5-0.6 wt. %, and zinc in an amount of 0.1-1.0 wt. %, preferably 0.2-0.9, preferably 0.3-0.8, preferably 0.4-0.7, preferably 0.5-0.6 wt. %, based on total weight of the membrane.

In some embodiments, the active layer has a thickness of 100 to 500 nm, preferably in the range of 100-500, preferably 110-490, preferably 120-480, preferably 130-470, preferably 140-460, preferably 150-450, preferably 160-440, preferably 170-430, preferably 180-420, preferably 190-410, preferably 200-400 nm, on the support.

In an embodiment, the membrane has pores with the largest dimension of 0.5-5 nm, preferably 1-4.5, preferably 1.5-4, preferably 2-3.5, and preferably 2.5-3 nm. In an embodiment, the membrane has a water contact angle of less than 25°, preferably 1°, preferably 2°, preferably 3°, preferably 4°, preferably 5°, preferably 6°, preferably 7°, preferably 8°, preferably 9°, preferably 10°, preferably 11°, preferably 12°, preferably 13°, preferably 14°, preferably 15°, preferably 16°, preferably 17°, preferably 18°, preferably 19°, preferably 20°, preferably 21°, preferably 22°, preferably 23°, preferably 24°, and preferably 25°. In a specific embodiment, the membrane has a water contact angle of ˜20°. The small contact angle value is highly desirable for a higher permeate flux, consequently, better antifouling characteristics.

In an embodiment, the membrane has an average surface area roughness of 24-29 nm, preferably 25-28, preferably 26-27 nm. In an embodiment, the membrane has a zeta potential ranging from −5 to −7 mV, preferably −5 mV, preferably −6 mV, preferably −7 mV.

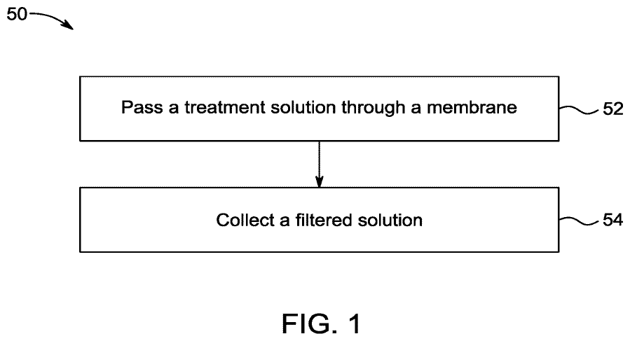

A method for removing an organic micropollutant from a treatment solution is described. is described. FIG. 1 illustrates a flow chart of method 50 of a method of removing an organic micropollutant from a treatment solution is described. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes passing a treatment solution through a membrane. The treatment solution can be wastewater, drinking water, or seawater. The treatment solution may contain organic micropollutants such as pharmaceuticals, personal care products, dyes, ionic salts, or a combination thereof. In an embodiment, the treatment solution includes 1-500 ppm of the organic micropollutant, based on a total weight of the treatment solution, preferably 5-495, preferably 10-490, preferably 15-485, preferably 20-480, preferably 25-475, preferably 30-470, preferably 35-465, preferably 40-460, preferably 45-455, preferably 50-450, preferably 55-445, preferably 60-440, preferably 65-440, preferably 70-435, preferably 75-430, preferably 80-425, preferably 85-420, preferably 90-415, preferably 95-410, preferably 100-405, preferably 105-400, preferably 110-395, preferably 115-390, preferably 120-385, preferably 125-380, preferably 130-375, preferably 135-370, preferably 140-365, preferably 145-360, preferably 150-355, preferably 155-350, preferably 160-345, preferably 165-340, preferably 170-335, preferably 175-330, preferably 180-325, preferably 185-320, preferably 190-315, preferably 195-310, preferably 200-305, preferably 205-300, preferably 210-295, preferably 215-290, preferably 220-285, preferably 225-280, preferably 230-275, preferably 235-270, preferably 240-265, preferably 245-260, and preferably 250-255 ppm.

In some embodiments, the pollutant is a pharmaceutically active compound. Pharmaceutically active compounds are emerging environmental contaminants widely used in human and veterinary medicine. Domestic disposal and hospital sewage discharge are the primary sources of release of these substances and their metabolites into the environment. Suitable examples of pharmaceutically active compounds include cetaminophen, metoprolol, caffeine, antipyrine, sulfamethoxazole, flumequine, ketorolac, atrazine, isoproturon, 2-hydroxybiphenyl, diclofenac, amitriptyline, and loperamide. Certain other examples include, analgesics (for example: propoxyphene); anticonvulsants (for example: phenytoin); anti-depressants (for example: fluoxetine (Prozac), sertraline (Zoloft), amitriptyline, protriptyline, trimipramine maleate, nortriptyline, desipramine, imipramine, doxepin, nordoxepin, paroxetine); anti-inflammatory (for example: methyprednisolone, prednisone); hormones (for example: equilin, 17β-estradiol, estrone, 17α-ethynyl estradiol, medroxyprogesterone, megestrol acetate, mestranol, progesterone, norethindrone, norethynodrel, norgestrel, cholesterol); antibiotics (for example: norfloxacin, lincomycin, oxytetracycline HCl, ciprofloxacin, ofloxacin, trimethoprim, penicillin G. 1/2-benzathine salt, sulfamethoxazole, penicillin V potassium salt, tylosin tartrate). In a specific embodiment, the organic micropollutant is sulfamethoxazole (SMX). In another embodiment, the organic micropollutant is Amitriptyline (ATT). In yet another embodiment, the organic micropollutant is Omeprazole (OMZ). In an embodiment, the organic micropollutant is Loperamide HCl (LOP).

In some embodiments, the organic micropollutant pollutant is a dye. Suitable examples of dyes include, alkaline methylene blue, methylene blue, tetrazine, acid orange, phenolic phenol, bisphenol, 2,4 dichlorophenol, Congo red, toluene, chromium ions, bromate ions, eosin yellow, etc. In some embodiments, the pollutant is an ionic salt, such as but not limited to sodium chloride, magnesium chloride, potassium chloride, or sodium carbonate.

At step 54, the method 50 includes collecting a filtered solution. The filtered solution includes at least 50% less, preferably 60%, 70%, 80%, or 90% less of the organic micropollutant than the treatment solution. In some embodiments, the membrane removes all of the organic micropollutant from the treatment solution.

While not wishing to be bound to a single theory, it is thought that a combination of the hydrophilicity (low contact angle), the less negative zeta potential, and the morphology of the membrane, specifically the active layer, results in an improved permeate flux, better antifouling characteristics, and enhanced rejection of pollutants. Covalent cross-linking of ZnO through the amine groups during the interfacial polymerization cause the particles to stay in place and form well-defined nanochannels, and prevents undesired defects and inhomogeneity. Further, the hydrophilic functional groups of the functionalized ZnO nanoparticles weakens the hydrophobic interactions that occur between the organic molecules and the membrane thereby decreasing the subsequent deposition of the organic molecules. Also, due to the simultaneous presence of oxide and free amine groups, the highly hydrophilic nature forms a hydration layer that discourages microbial attachment.

### EXAMPLES

The following examples demonstrate a method of removing an organic micropollutant from a treatment solution as described herein. The examples are provided solely for illustration and are not to be construed as limitations of the present disclosure, as many variations thereof are possible without departing from the spirit and scope of the present disclosure.

### Example 1: Materials

The monomers for synthesizing the active layer, piperazine, and trimesoyl chloride, were purchased from Sigma Aldrich, Inc. Zinc acetate and NaOH of reagent grade used to synthesize ZnO nanoparticles were also purchased from Sigma Aldrich, polysulfone was also acquired from the Sigma Aldrich to form the support for the active layer. Commercial nanofiltration (NF) membranes for comparison of organics rejection, XN45 and NFG (Sterlitech, Inc.), were used without further modification. The analytes for the rejection experiments were of high purity (>99.8%) and purchased from Sigma Aldrich, Inc. The analytes were selected based on their occurrence in natural water sources and their relevant characteristics, such as MW, electric charge, hydrophobicity, etc. (Table 1).

TABLE 1
Properties of the organic pharmaceuticals contaminants used in this study

| | Pharmaceutical contaminants | | | |
|---|---|---|---|---|
| Characteristic | Sulfamethoxazole | Amitriptylene | Omeprazole | Loperamide |
| Name | (SMX) | (ATT) | (OMZ) | HCl |
| Molecular | 253 | 313 | 343 | 513.5 |
| weight | | | | |
| (g/mol) | | | | |
| Solubility | 600 | 9.7 | 82.3 | 77 [ug/mL] |
| (mg/L) | | | | |
| Log K_{ow} | 0.89 | 4.92 | 2.23 | 5.15 |
| pKₐ | pKₐ (1) = 1.6, | 9.5 | 8.8 | 8.66 |
| | pKₐ (2) = 5.6 | | | |
| Stokes | 0.38 | 0.56 | 0.48 | 0.66 |
| radius (nm) | | | | |
| Surface | negative | | neutral | |
| Charge | | | | |
| (pH ~7) | | | | |

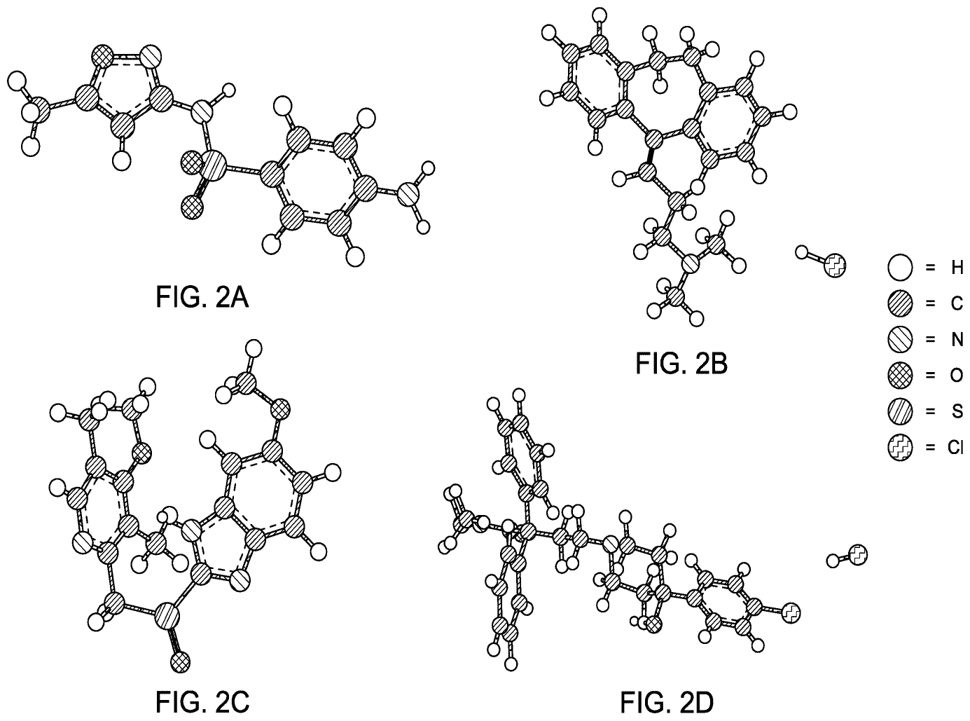

ATT hydrochloride is the most widely used tricyclic antidepressant. SMX is a commonly used antibiotic for bacterial infections such as urinary tract infections, bronchitis, and prostatitis and is effective against gram-negative and positive bacteria. OMZ is used to treat heartburn, a damaged esophagus, stomach ulcers, and gastroesophageal reflux disease (GERD). Loperamide HCl, sold under the brand name Imodium, is used to treat malfunctioning of the digestive system. The molecular structures of the analytes, SMX, ATT, OMZ, and Loperamide HCl are given in FIGS. 2A-2D.

Table 2 provides the manufacturer's data on the two commercial membranes. The XN45 from Trisep™ is a piperazine-based nanofiltration membrane with the versatility to be used in process streams and low-pressure water purification. XN45 elements have a high rejection of divalent ions while allowing the majority of monovalent ions to pass through the membrane. On the other hand, the NFG is a loose nanofiltration membrane, providing high flux and moderate levels of lactose and MgSO₄ rejection. With a molecular weight cut-off of 600 to 800 Daltons, it is used for applications requiring a large amount of salt removal. It is commonly used in the dairy industry for milk processing.

TABLE 2
Information and performance data of the commercial membranes

| Mem- | Active | MWCO | | Flux | Rejection |
|---|---|---|---|---|---|
| brane | Layer | (Da) | Application | (GFD/psi) | (%) |
| XN45 | PPA-TFC | ~500 | Foods/Industrial/ | 60/200 | 95.0% MgSO₄ |
| | | | Wastewater | | 10-30% NaCl |
| NFG | Proprietary | 600-800 | Dairy industry | 55-60/110 | 50.0% MgSO₄ |
| | PA TFC | | | | 10% NaCl |

### Example 2: Synthesis of ZnO Nanoparticles

A co-precipitation method was used to synthesize the ZnO nanoparticles [Z. Mohammad Redha, H. Abdulla Yusuf, S. Burhan, I. Ahmed, Facile synthesis of ZnO nanospheres by co-precipitation method for photocatalytic degradation of azo dyes: optimization via response surface methodology, International Journal of Energy and Environmental Engineering. 12 (2021) 453-466]. The ZnO nanoparticles were synthesized by the reaction of Zn (CH₃COO)₂ 2H₂O and NaOH. In brief, the 0.1 M solution of the Zn (CH₃COO)₂ 2H₂O was heated to 60° C., and the 0.2 M NaOH solution was added dropwise under a constant stirring of 500 rpm. The zinc acetate and sodium hydroxide solution were heated at 60° C. for 3 hours. After 3 hours, the solution of the Zn (CH₃COO)₂. 2H₂O and the NaOH turned into a white precipitate. The precipitate was further cooled to room temperature. The white precipitate was collected by centrifuging the precipitates at 4500 rpm and washed several times to remove the unreacted precursors. The obtained white solid was dried at 100° C. and stored at room temperature for further use.

### Example 3: Functionalization of TAS Functionalized ZnO Particles

The surface hydroxyl group on the ZnO particles helps to immobilize the amino silane on these particles. In brief, 1% ZnO mixture was prepared in ethanol with N1-(3-trimethoxysilylpropyl) diethylenetriamine (TAS) and heated at 90° C. in an oil bath using a reflux condenser for 24 hours. After 24 hours, the TAS functionalized ZnO was cooled to room temperature and centrifuged to collect the solid. The solid was washed several times with ethanol, dried at 60° C., and stored at room temperature for further use.

### Example 4: Membrane Synthesis

The polysulfone (PS) support was prepared using a phase inversion process. For the active layer, a 2% solution of piperazine was prepared in double distilled water. A 3% solution of triethylamine was prepared. A 0.2% solution of trimesoyl chloride (TMC) or 1,3,5-benzenetricarbonyl trichloride was prepared in hexane. First, the piperazine solution was poured on the surface of the PS support, and the membrane surface was dipped in it for 5 min. After that, the aqueous solution was removed, and the excess solution was wiped out with the rubber roller. After removing the excess of the aqueous phase, the membrane was exposed to the TMC solution for 1 minute. After that, the TMC solution was removed from the membrane surface and washed thoroughly with hexane. Triethylamine was added as an acid quencher produced during the interfacial polymerization of the piperazine and the TMC. FIG. 3A illustrates the formation of the pristine piperazine-based thin film composite (TFC) membrane. This membrane, without the ZnO nanoparticles, is labeled throughout as the pristine TFC membrane, or pristine membrane.

The thin-film nanocomposite (TFN) membranes (Z-PiP-TFN and TAS-Z-PiP-TFN) were made in a similar fashion except that these membranes contained 50 ppm of ZnO and the TAS functionalized ZnO in the aqueous phase, respectively. The freshly prepared TFC and the TFN membranes were aged at 80° C. to enhance the intensity of the cross-linking. The developed membranes were stored in deionized water for their performance evaluation. The membrane including the ZnO without surface modification with TAS is labeled as Z-PiP-TFN and the membrane including the ZnO with surface modification with TAS is labeled as TAS-Z-PiP-TFN throughout. FIG. 3B depicts the formation of the TAS-Z-PiP-TFN based membranes.

### Example 6: Membrane Characterization Techniques

The synthesized membranes were characterized using an array of techniques to assess the relevant surface characteristics such as hydrophilicity, chemistry, morphology, and topography. The samples were scanned with Attenuated Total Reflectance Fourier Transform Infrared Spectroscopy (ATR-FTIR) using a spectrometer in the wavelength range 400-4,000 cm-1. A total of 32 scans were done for a location, and membrane samples were scanned from 3-4 different locations. The entire FTIR spectra for the different membranes were taken on the same plot for comparison purposes. A contact angle goniometer (DSA-25, Kruss Inc., Hamburg, 85 Borsteler Chaussee, Germany) was used to measure the hydrophilicity of the membrane surfaces. Samples of approximate dimensions 1 cm×4 cm were cut and fixed to glass slides using tape. A droplet of volume ˜10 μl was placed on the surface, and the equipment software measured the angle. Measurements were repeated from at least five locations, and the average value was taken. A scanning electron microscope (JEOL, Ltd., 3-1-2 Musashino, Akishima, Tokyo, Japan) was used to study the surface morphology of the membrane samples. Square-shaped specimens of approx. dimensions 1 cm² were cut and fixed to a metallic sample holder using double-sided adhesive tape. To make the samples conductive, they were coated with a gold film of thickness ˜5-10 nm by sputter deposition. The entire surface of the specimens was scanned, and images were taken at different magnifications. A benchtop AFM with basic features (Easyscan, Nanosurf, Liestal, Switzerland) was used for the surface roughness measurements. Membrane specimens fixed onto glass slides were placed, clamped on a circular stage, and placed directly beneath the laser. The scanning was performed in tapping (non-contact) mode with a silicon nitride cantilever. An area of 10 μm was scanned with a speed of ˜ 0.8 lines/sec.

### Example 7: Filtration Studies

Membrane filtration was tested with an all-inclusive membrane testing skid (Sterlitech, Inc., 4620 B St NW Ste 101, Auburn, Washington, 98001, United States). This consisted of a trolley in which all major components (membrane cells, pump, feed tank, and recirculating chiller) were fixed and inter-connected by Teflon and stainless steel tubings. A total of 3 membrane cells (CF042) in the parallel configuration were connected to the feed tank, which was of conical shape and had circular coils in its lower half. When the chiller was turned on, the coolant circulated through these coils and maintained the feed at a desired temperature. The flow rate through the cells and the feed pressure were controlled by employing valves opened/closed by knobs below the membrane cells.

For every filtration run, the membranes were first compacted for 1-2 hours at a pressure of ˜250 psi. After compaction, the pressure was adjusted to ˜200 psi, and the permeate was collected in plastic vials of 50 ml for 5-10 minutes. The flux was calculated using the formula:

$$J = \frac{V}{A \times t}$$

J is the calculated flux in L/m²h, Vis the volume of permeate collected, A is the active area of the membrane, and t is the time for which permeate was collected.

In a similar manner, the salt rejection was also estimated for the membranes. The feed and permeate TDS were measured using an Ultrameter (Myron Instruments, 2450 Impala Dr, Carlsbad, California, 92010, United States). The standard formula was used to calculate the rejection below.

$$R = \frac{{C}_{f} - {C}_{p}}{{C}_{f}} \times 100$$

The same membrane testing skid was used in cross-flow mode to determine the % removal of the organic compounds by the different membranes. As with regular filtration studies, the membranes were soaked overnight and then compacted at ˜ 250 psi for 2-3 hours. After stabilization at 200 psi and flux measurements, a 10-ppm organic compound solution was added. After a 10 min waiting period for mixing, the permeate from all the cells was collected in a 1 L glass conical flask to minimize the possible adsorption onto the container walls. The total permeate was recycled back to the feed after every 30 min or 200 ml collection, depending on which one occurred first.

Feed samples were collected in 25 mL glass beakers and stored in glass vials to measure the concentration of organic compounds. The feed sample was collected from the middle of the tank to ensure better representation. The permeate from each cell was collected separately in 50 mL glass conical flasks after 1 hour of organics addition to the feed. The organics concentration in the feed and permeate was determined using a UV-Vis spectrophotometer. The % rejection was then calculated based on the difference between the intensities of the absorbed wavelength as shown below.

$$R = \frac{{I}_{F} - {I}_{P}}{{I}_{P}} \times 100$$

### Example 8: Membrane Characterization

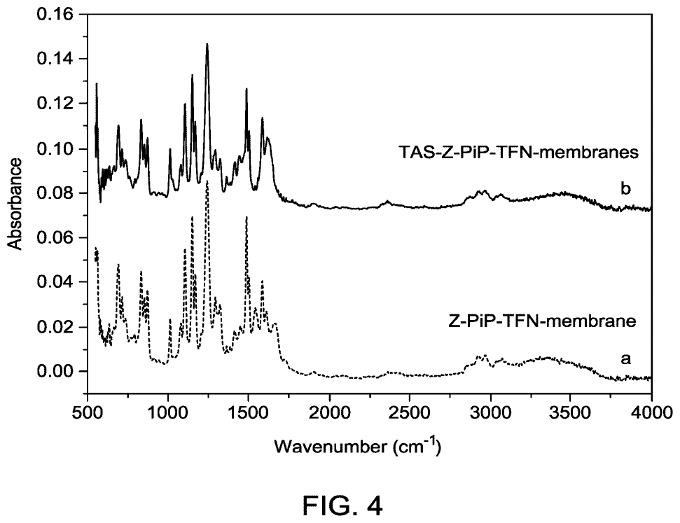

The FTIR spectra of the non-functionalized and functionalized incorporated thin film nanocomposite membranes can be observed in FIG. 4. The FTIR spectra show peaks of the piperazine-based polyamide active layer. In the Z-PIP-TFN membrane (a), the —C—O carbonyl peak of the polyamide was observed at 1662 cm⁻¹. Another absorption band was observed at about 1730 cm⁻¹, which is attributed to the hydrolyzed acid chloride transformation into carboxylic acid during the interfacial polymerization reaction. In the case of the TAS functionalized ZnO grafted piperazine-based membrane (b), the pattern of peaks was similar; however, some distinguished differences were observed, indicating the successful grafting of the TAS functionalized ZnO grafting into the active layer of the TFN membrane. A slight shift in the C═O of the polyamide absorption band appeared at 1658 cm⁻¹. In the case of the TAS-Z-PiP-TFN-membrane (b), an absorption band appeared at 1730 cm⁻¹ in the Z-PiP-TFN-membrane was absent, which is an indication that due to the excess of the amine group immediately consumed, the acid chloride to form the amide linkage. The most notable peak of ˜1,540 cm⁻¹ attributed to the amide II band (N—H bend) appeared in the Z-PiP-TFN and TAS-Z-PiP-TFN membranes. The absorption band appeared at 1580 cm⁻¹, 1503 cm⁻¹, and the 1486 cm⁻¹ was attributed to the aromatic —C═C-vibrations, which appeared from the aromatic ring of the polysulfone backbone, and these absorption bands are prominent in both Z-PiP-TFN and TAS-Z-PiP-TFN membranes. The aliphatic-CH stretching vibrations were observed in the range of 2830 to 3000 cm-1, and the aromatic-C—H stretching was observed in the range of 3000 to 3100 cm-1. The broad absorption band in the region of 3200 to 3700 cm-1 was attributed to the v (O—H) and v (N—H) stretching modes.

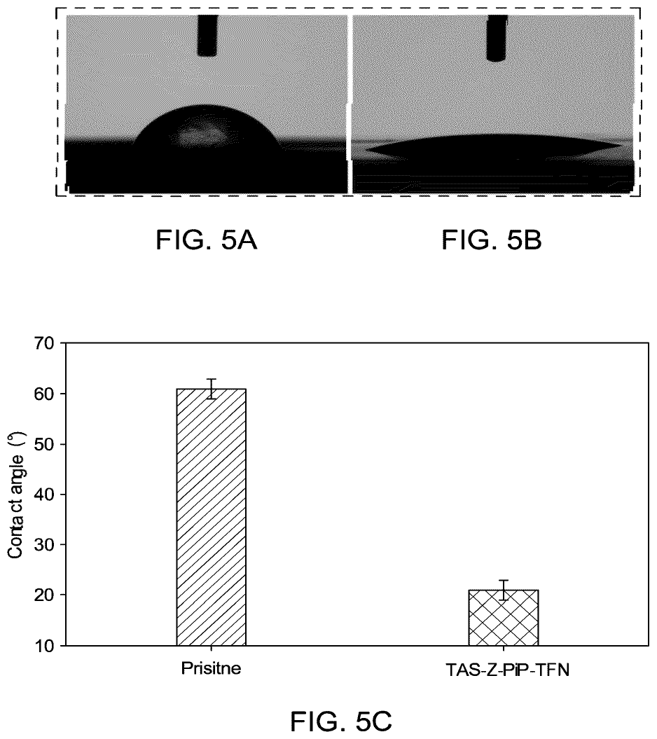

The wetting behavior of the membrane surface is important to the filtration characteristics as well as the fouling propensity. The average contact angle (CA) values for the pristine (FIG. 5A) and the TAS-Z-PiP-TFN-membranes (FIG. 5B) are depicted. The pristine membrane has a CA of ˜60°, which is typical for commercial poly piperazine/amide membranes (FIG. 5A). Although hydrophilic groups (COO and NH) are present on the surface, the aromatic ring has a hydrophobic character. The cross-linking of ZnO particles functionalized with amine (N—H) groups generates a surface that is easily wetted by water, and the CA values reduce to ˜ 20° (FIG. 5B). The increase in the hydrophilicity can be explained by dual factors: (i) ZnO, like many metal oxides, is hydrophilic due to the lone pair of electrons on the oxygen atoms that have the ability to undergo hydrogen bonding with water molecules and (ii) the amine groups present around the particles are also hydrophilic in nature. The free amine group can be easily protonated under the operation condition and facilitate the spread of the water on the surface of the TAS-Z-PiP-TFN-membrane. The small contact angle value is desirable due to higher permeate flux, better antifouling characteristics, and enhanced rejection of pharmaceuticals. FIG. 5C is a histogram showing the values of the WCA on the surface of the pristine TFC and TAS-Z-PiP-TFN membrane.

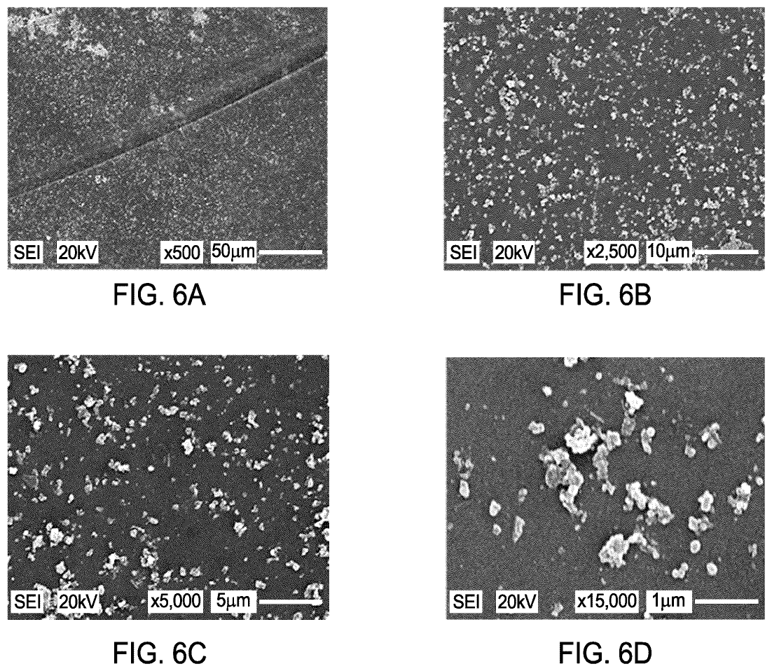

FIGS. 6A-6D show SEM images of the TAS-Z-PiP-TFN-membrane surface at different magnifications. It is observed that the functionalized oxide particles are uniformly distributed throughout and cover the entire surface (FIG. 6A). This is highly desirable for several attributes, including high permeate flux, efficient rejection of trace organic compounds, and good antifouling behavior. The uniform distribution is observed even when focusing on smaller regions (FIG. 6B, although some gaps can be observed at higher magnifications (FIG. 6C).

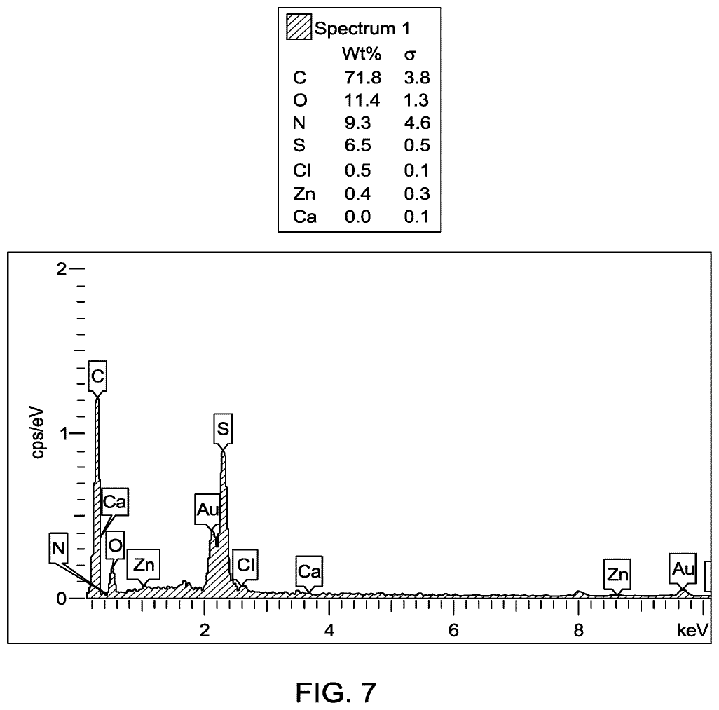

A good idea about the shape and size of the particles is obtained from images at even higher magnifications (FIG. 6D). Some particles are spherical, while others have an irregular shape. Similarly, there is observed variation in the size, with the smallest in the range of 100-200 nm and others close to half a micron. Also, agglomeration of the particles is visible in several locations, which is due to the presence of N—H groups in their vicinity and the silane groups, which has made a network around the ZnO and resulted in the agglomerated particles. EDX analysis confirms that the particles are indeed ZnO and that they are functionalized with amine groups (FIG. 7).

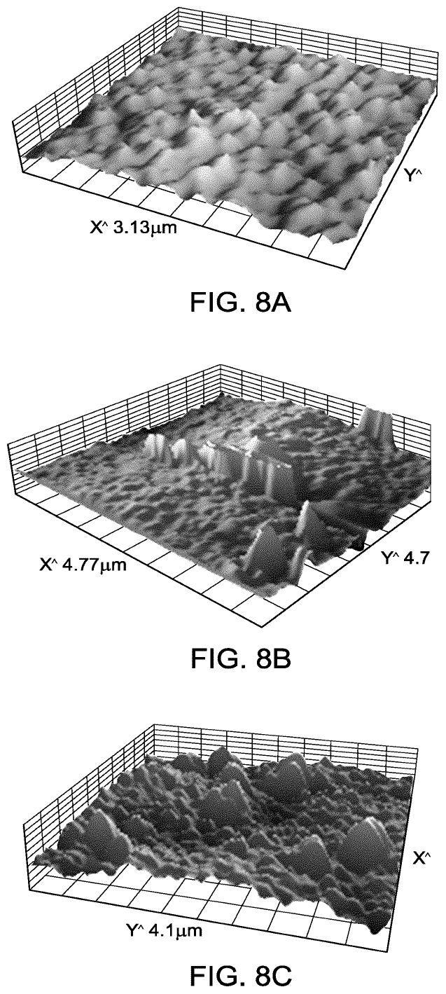

Another characteristic that influences filtration as well as fouling behavior, is the surface roughness of the membrane. Typically, rougher surfaces are more prone to fouling as the foulants may deposit into the valleys and are difficult to remove by shear forces. The 3-D AFM images for the pristine TFC, Z-PiP-TFN and TAS-Z-PiP-TFN membranes are depicted in FIGS. 8A-8C, respectively. The pristine membrane has a peak-and-valley structure typical of commercial NF/RO membranes. However, the difference between peak and valleys is not very high, with an average roughness <20 nm (FIG. 8A). Incorporating ZnO particles in the active layer increases the surface roughness due to higher peaks, identified as white mountains in the AFM images of both Z-PiP-TFN and TAS-Z-PiP-TFN membranes (FIGS. 8B & C). As seen in SEM images (FIGS. 6A-6D), some of the nanoparticles lie at the surface as projections, increasing the roughness.

However, there is a clear difference in the distribution of the white peaks between the Z-PiP-TFN and TAS-Z-PiP-TFN-membranes. In the Z-PiP-TFN membrane, the peaks have an uneven distribution, with several of them right next to each other in some locations (indicating agglomeration), and some far apart (FIG. 8B). On the other hand, the peaks are more equidistant in the TAS-Z-PiP-TFN-membrane, with individual peaks at some distance to each other (FIG. 8C). One of the influencing factors, is the functionalization of ZnO with linkers containing the N—H groups which help in covalently cross-linking the nanoparticles into the active layer of the TAS-Z-PiP-TFN membrane, which is absent in Z-PiP-TFN. Non-functionalized ZnO agglomerated severely and may cause unwanted defects in the active layer of the Z-PiP-TFN membrane, which can impact the separation performance of the membranes. Covalent cross-linking of TAS functionalized ZnO through the amine groups during the interfacial polymerization cause the particles to stay in well-defined locations and prevents undesired defects, which can help improve the performance of the membranes.

The above-mentioned differences are reflected in the roughness values obtained for the different membranes (Table 3). The pristine membrane is the smoothest, with average and root-mean-square roughness values of ˜18 and 23 nm, respectively. Such values are typical of commercial NF membranes with polyamide or polypiperazine amide as the active layer.

TABLE 3
Roughness parameters for the membranes
using AFM measurements.

| | Area roughness (nm) | | | Line roughness (nm) | | |
|---|---|---|---|---|---|---|
| Membrane | Sₐ | S_{q} | S_{y} | Rₐ | R_{q} | R_{y} |
| Pristine TFC membrane | 18.1 | 23.2 | 172.3 | 14.3 | 17.2 | 74.5 |
| Z-PiP-TFN membrane | 30 | 41 | 523 | 32.3 | 37.6 | 129 |
| TAS-Z-PiP-TFN membrane | 27.5 | 36.7 | 390.1 | 25.2 | 34.6 | 112.4 |

The membranes incorporating the oxide nanoparticles have higher values of the roughness parameters, as evident from the data in Table 3, with average roughness being ˜30 and 27.5 for the Z-PiP-TFN membrane and TAS-Z-PiP-TFN membrane, respectively. Similarly, the line profiles show similar characteristics for both membranes, with the Z-PiP-TFN displaying higher peaks than the TAS-Z-PiP-TFN membrane.

A characteristic of membranes in water treatment is the surface charge that influences permeate flux, solute rejection/passage, fouling, etc. It is assessed by measuring the surface zeta potential with a streaming potential or zeta analyzer. FIG. 9 shows the zeta potential values for the in-house synthesized membranes at a neutral pH. The pristine TFC membrane has a large negative value (˜−21 mV), indicating a strong negative charge that is contributed by the hydrolyzed acid chloride into carboxylic acid produced during the interfacial polymerization of the piperazine and the TMC. Thus, the negative charge is contributed by the deprotonation of carboxylic groups (COO⁻) at pH>4 and is quite typical of commercial PA membranes. Incorporating non-functionalized ZnO particles into the active layer has shown the zeta potential to ˜−10 mV (Z-PiP-TFN), implying a reduction in the negative charge. When NPs functionalized with TAS containing the N—H groups are cross-linked into the active layer, the TAS-Z-PiP-TFN membrane shows an even smaller negative value (˜−6.2 mV).

The change in zeta potential can be explained as follows: when simple ZnO NPs are present on the membrane surface, the density of the carboxylic groups from polyamide is reduced, and hence a lower negative charge results. When the identical particles are functionalized with TAS linkers, the negative charge decreases further because the free amines of the TAS linker, which are not cross-linked, can get protonated. Hence, the zeta potential of the TAS-Z-PiP-TFN membrane moved to positive at a neutral pH.

### Example 9: Filtration Properties

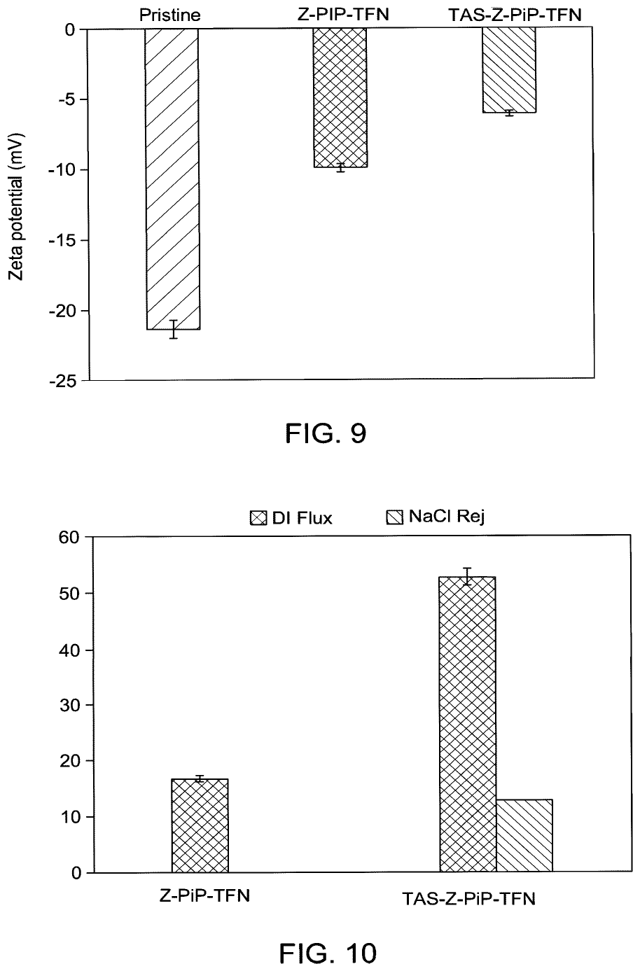

The filtration properties of the membranes were assessed with pure water as well as a synthetic salt solution. FIG. 10 compares these parameters for the Z-PiP-TFN and TAS-Z-PiP-TFN membranes. The permeate flux increases by approximately ten times after the incorporation of TAS-functionalized ZnO particles, while the increase is only 3 times for the unfunctionalized ZnO particles. The higher increase for the TAS-Z-PiP-TFN membrane can be explained by the presence of uniform and homogeneous nanochannels formed by the TAS functionalized ZnO particles. These nanochannels provide preferential pathways for the water molecules to pass through. The presence of free N—H groups further increases the hydrophilicity of the TAS-Z-PiP-TFN membrane surface. However, simply including ZnO nanoparticles without functionalization does not impact water transport. The distribution of NPs is not very uniform at the membrane surface, as they preferentially form clusters. Furthermore, the non-functionalized ZnO incorporated membrane showed a low permeation flux and defects in the Z-PiP-TFN membrane, resulting in no rejection of NaCl.

The rejection of monovalent salt, NaCl, was also determined using a 2,000-ppm feed solution. The introduction of the nanoparticles increases the salt passage, due to an increase in the average pore size. Also, the nanochannels created by the NPs, allow a good portion of the salt ions to pass through as well. However, the low rejection of the salt was more prominent in the case of the Z-PiP-TFN membrane. It can be explained that the non-functionalized ZnO incorporated membrane showed a low permeation flux and defects in the Z-PiP-TFN membrane resulting in no rejection of NaCl.

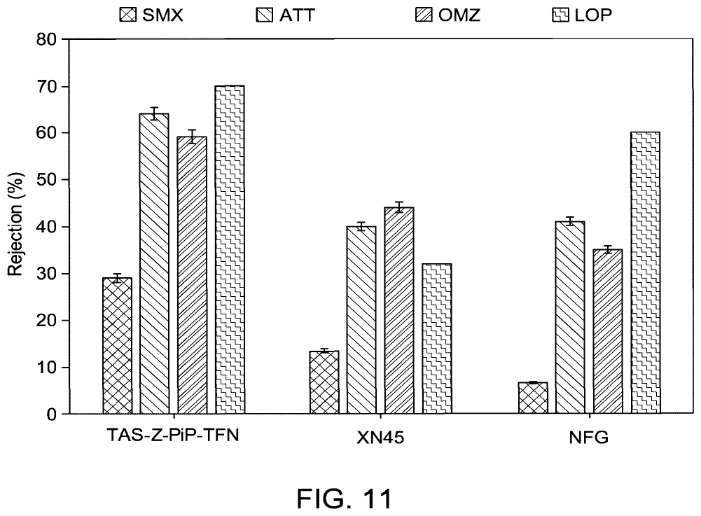

Membranes are increasingly used to efficiently remove trace organic compounds from wastewater, such as pharmaceuticals, personal care products, etc. The synthesized membranes were assessed for rejection of four pharmaceuticals commonly found in water and wastewater sources: SMX, ATT, OMZ, and LOP. The rejection performance for the TAS-Z-PiP-TFN-membrane was compared with two commercial NF membranes, XN45 and NFG. The XN45 is a piperazine-based NF membrane with an MWCO of ˜500 Da and is designed for low-pressure applications. On the other hand, the NFG is a loose NF membrane with an MWCO in the range 600-800 Da. FIG. 11 shows the rejection of all the above pharmaceuticals by the membranes.

The above results show that the TAS-Z-PiP-TFN-membrane outperforms both commercial membranes in removing all the organic compounds. Beginning with the lowest molecular weight, SMX, the TAS-Z-PiP-TFN-membrane was able to remove ˜30%, whereas the rejections were only ˜7% and 13.5% for the NFG and XN45, respectively. Similarly, the TAS-Z-PiP-TFN-membrane removed ˜64 and 60% of the two compounds with moderate molecular weights, ATT and OMZ, respectively. On the other hand, the commercial membranes had a rejection in the range of ˜35-44% only. The higher MW Lop HCl rejections were 70, 32, and 60% for the TAS-Z-PiP-TFN-membrane, XN45, and NFG, respectively.

The higher rejections for membrane can be explained based on its molecular structure. The presence of TAS-functionalized nanoparticles with hydrophilic functional groups e.g., N—H, Si—O in, TAS-Z-PiP-TFN-membrane weakens the hydrophobic interactions that occur between the organic molecules and the PA layer of the membrane. These hydrophobic interactions result in the sorption of organic molecules on the surface and inside the active layer and their ultimate desorption and passage through the membrane. Given the uniform and homogeneous presence of the functionalized NPs throughout the entire membrane surface (FIGS. 5 & 6), the feed containing the pharmaceuticals must consistently interact with the complex functionalities on the surface. The passage of organic molecules through the membrane involves both sorption on the membrane surface and their transport by diffusion. It is hypothesized that the hydrophilic nanochannels created by the incorporation of the functionalized NPs also impede the diffusion of the organic molecules.

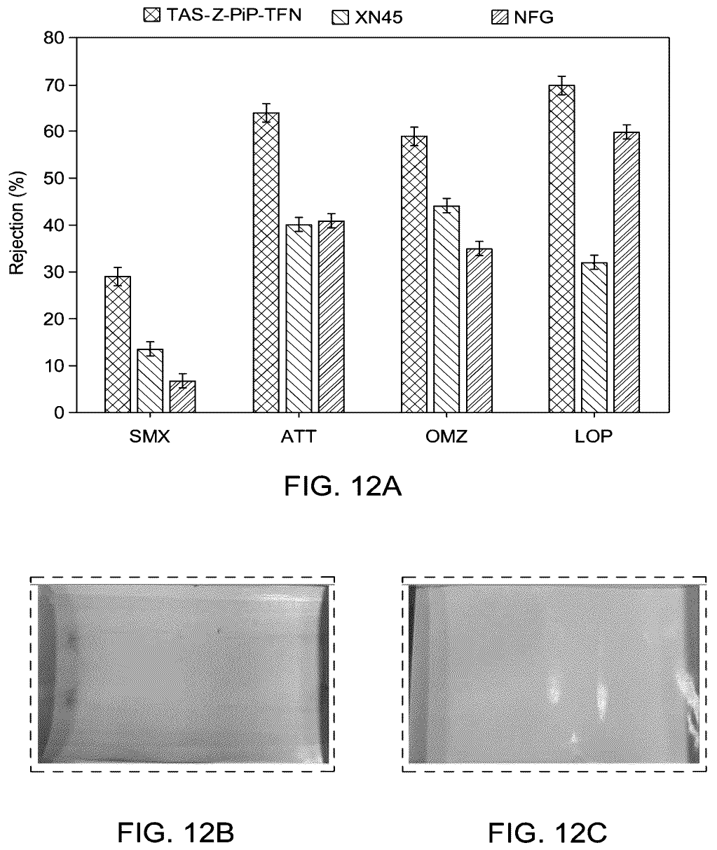

FIG. 12A shows the percent rejections for each pharmaceutical compound by each membrane. A superior rejection performance of the TAS-Z-PiP-TFN-membrane can be observed for each analyte. The pictures of the XN45 (FIG. 12B) and the TAS-Z-PiP-TFN (FIG. 12C) membranes after running with ˜10 ppm Loperamide feed for approx. 4 hours. The XN45 is covered entirely with a fouling layer due to the deposition of the organic compound. On the other hand, the TAS-Z-PiP-TFN membrane appears very clean with negligible organic deposition (FIG. 12C). The improved fouling resistance can be explained as follows: Lop HCl is hydrophobic in nature as testified by its log K_{ow} value (Table 1) and has a likelihood of hydrophobic interactions with the functional groups in the pristine TFC active layer. However, the presence of hydrophilic entities, ZnO NPs coupled with amine and silanol groups at regular intervals throughout the membrane surface, weaken these interactions and hence, decrease the subsequent deposition of the organic molecules.

In addition to the presence of trace organic compounds, wastewater effluent from domestic, industrial, and municipal sources typically contains a variety of bacterial species. These microorganisms tend to irreversibly attach to the membrane surface and cause biofouling, a major obstacle to the sustainability of water purification. Therefore, it is imperative for a membrane with high rejections of trace organic compounds to possess antibacterial traits as well.

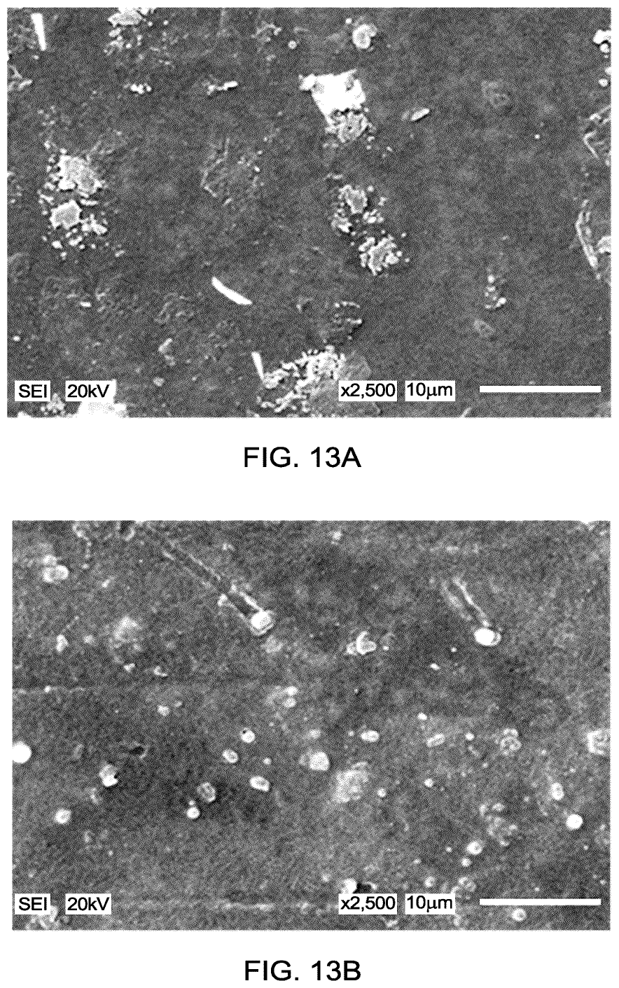

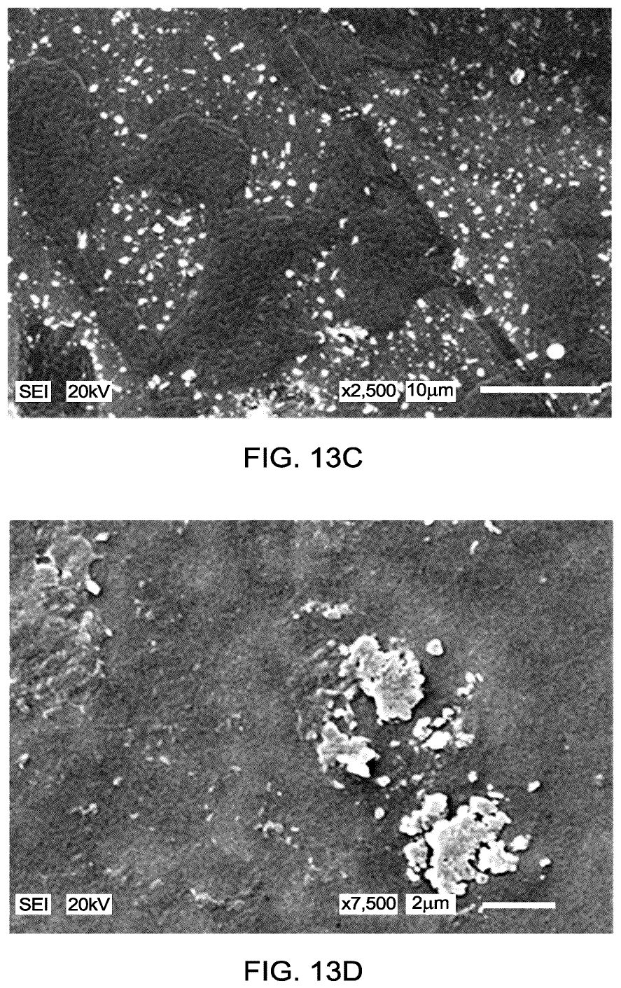

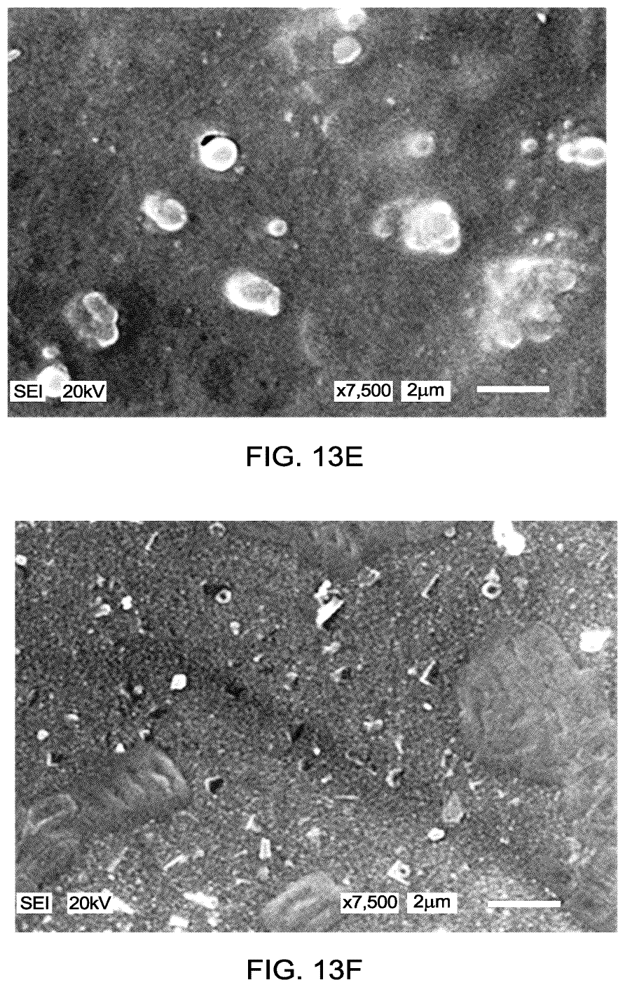

FIG. 13 shows some representative SEM images of the membranes after exposure to a suspension of P. aeruginosa of approx. concentration 107/mL. The pristine TFC membrane shows biofilm patches on its surface (FIGS. 13A & D), indicating bacterial cell biological activity. Polypiperazine-amide has plenty of unreacted carboxylic groups on its surface due to the incomplete reaction during interfacial polymerization. These groups are susceptible to fouling by organics and bacterial cells, which attach themselves readily to the surface, however, hardly any cells are visible on the TAS-Z-PiP-TFN-membrane (FIGS. 13B & E) that has ZnO NPs present at regular intervals. Due to the simultaneous presence of oxide and free amine groups, the highly hydrophilic nature forms a hydration layer that discourages microbial attachment. Also, the biological activity of any attached cells will most likely be curtailed by the ZnO nanoparticles that are known to have a bactericidal effect.

As opposed to this, the surface of the commercial XN45 has large colonies throughout the entire area (FIGS. 13C & F). Rod-shaped bacterial cells of approx. length 2 μm can be seen stacked side by side in large numbers. Although XN45 is hydrophilic, it is prone to the microbial attachment. One major difference with the pristine TFC membrane prepared in the lab is that biofilm patches are not seen on XN45. It is also complemented by the fact that the cells have deformed morphology, implying their inactivation by some functional groups present on the surface.

Numerous modifications and variations of the present invention are possible in light of the above teachings. It is therefore to be understood that within the scope of the appended claims, the invention may be practiced otherwise than as specifically described herein.

1. A method of removing an organic micropollutant from a treatment solution, comprising:
passing the treatment solution through a membrane; and
collecting a filtered solution,
wherein the filtered solution comprises at least 50% less of the organic micropollutant than the treatment solution,
wherein the membrane comprises:
a polysulfone support; and
an active layer comprising zinc oxide (ZnO) nanoparticles,
wherein the active layer further comprises polymerized units of a piperazine compound and an aromatic compound with at least three acyl chloride substituents,
wherein a surface of the ZnO nanoparticles is functionalized with a silane amine compound, and
wherein an amine group of the silane amine compound is crosslinked with at least one of the at least three acyl chloride substituents in the active layer.

2. The method of claim 1, wherein the ZnO nanoparticles have an average size of 100-500 nm.

3. The method of claim 1, wherein at least a portion of the ZnO nanoparticles are agglomerated and form agglomerates with an average size of 500-1,500 nm.

4. The method of claim 1, wherein at least a portion of the ZnO nanoparticles are spherical.

5. The method of claim 1, wherein the ZnO nanoparticles are uniformly distributed over an entire surface of the active layer, and wherein an average spacing between the ZnO nanoparticles is 0.5-3 μm.

6. The method of claim 1, wherein the membrane comprises 65-75 wt. % C, 5-15 wt. % 0, 5-15 wt. % N, 1-10 wt. % S, 0.1-1.0 wt. % Cl, and 0.1-1.0 wt. % Zn, based on a total weight of the membrane.

7. The method of claim 1, wherein the membrane comprises 10-100 ppm of the ZnO nanoparticles relative to a total weight of the active layer.

8. The method of claim 1, wherein the silane amine compound has a straight or branched chain with 4-20 atoms attached to a silane group, and
wherein the amine group crosslinked with at least one of the at least three acyl chloride substituents is a terminal amine group on the chain.

9. The method of claim 1, wherein the silane amine compound is N1-(3-trimethoxysilylpropyl) diethylenetriamine.

10. The method of claim 1, wherein the piperazine compound is piperazine.

11. The method of claim 1, wherein the aromatic compound with at least three acyl chloride substituents is 1,3,5-benzenetricarbonyl trichloride.

12. The method of claim 1, wherein the membrane has a water contact angle of less than 25°.

13. The method of claim 1, wherein the membrane has an average surface area roughness of 24-29 nm.

14. The method of claim 1, wherein the membrane has a zeta potential of from −5 to −7 mV.

15. The method of claim 1, wherein the active layer has a thickness of 100 to 500 nm.

16. The method of claim 1, wherein the membrane has pores with a largest dimension of 0.5-5 nm.

17. The method of claim 1, wherein the treatment solution comprises 1-500 ppm of the organic micropollutant, based on a total weight of the treatment solution.

18. The method of claim 1, wherein the organic micropollutant is at least one selected from the group consisting of sulfamethoxazole, amitriptyline, omeprazole, and loperamide.

19. The method of claim 1, wherein the treatment solution is wastewater, drinking water, or seawater.
